(19) United States
(12) Patent Application Publication
(10) Pub. No.: US 2019/0188649 A1
(43) Pub. Date: Jun. 20, 2019

(54) FILL-IN NOTIFICATIONS

(71) Applicant: Web.com Group, Inc., Jacksonville, FL (US)

(72) Inventors: Joshua Cain, New York, NY (US); Dekel Albocher, New York, NY (US); Patrick Chan, San Ramon, CA (US)

(21) Appl. No.: 16/182,980

(22) Filed: Nov. 7, 2018

Related U.S. Application Data
(60) Provisional application No. 62/607,025, filed on Dec. 18, 2017.

(51) Int. Cl. G06Q 10/10; H04L 12/58

(52) U.S. Cl. CPC G06Q 10/1095; H04W 4/14; H04L 51/22; H04L 51/24

(57) ABSTRACT

Disclosed are various embodiments for providing fill-in notifications to end users. A cancellation event is identified for an appointment corresponding to a timeslot. Then, an eligible user for a new appointment corresponding to the timeslot is identified. A notification is then sent to the eligible user. The notification can include a request for the eligible user to schedule the new appointment for the timeslot.

This application claims priority to, and the benefit of, U.S. Provisional Patent Application No. 62/607,025, entitled “FILL-IN NOTIFICATIONS” and filed on Dec. 18, 2017, which is incorporated by reference as if set forth herein in its entirety.

### BACKGROUND

Customers often make appointments with service providers. However, such customers sometimes cancel their appointments on relatively short notice (e.g., one, two, or three days before an appointment). When appointments are cancelled on such short notice, they can be hard to replace. This results in gaps in the service provider's schedule that did not previously exist.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a flowchart illustrating one example of functionality implemented as portions of an application executed in a computing environment in the networked environment of FIG. 1 according to various embodiments of the present disclosure.

FIG. 3 is a schematic block diagram that provides one example illustration of a computing environment employed in the networked environment of FIG. 1 according to various embodiments of the present disclosure.

### DETAILED DESCRIPTION

Disclosed are various embodiments of technical solutions to the technical problem of filling timeslots for cancelled appointments. Practice management systems for service providers often allow service providers to track when customers are scheduled to have an appointment, how long the appointment is, and what service the appointment is for. When a customer cancels an appointment, the service provider may record the cancellation in the practice management system. However, the practice management systems have historically been unable to automatically schedule another appointment with another customer in place of a portion or all of the timeslot that was previously reserved for the cancelled appointment. The various embodiments of the present disclosure allow for services providers to automatically contact and schedule appointments with other customers in response to a cancellation of an appointment, such as through the use of additional software that plugs into or otherwise extends the functionality of practice management systems or as an additional feature implemented as a component of a practice management system itself. In the following discussion, a general description of the system and its components is provided, followed by a discussion of the operation of the same.

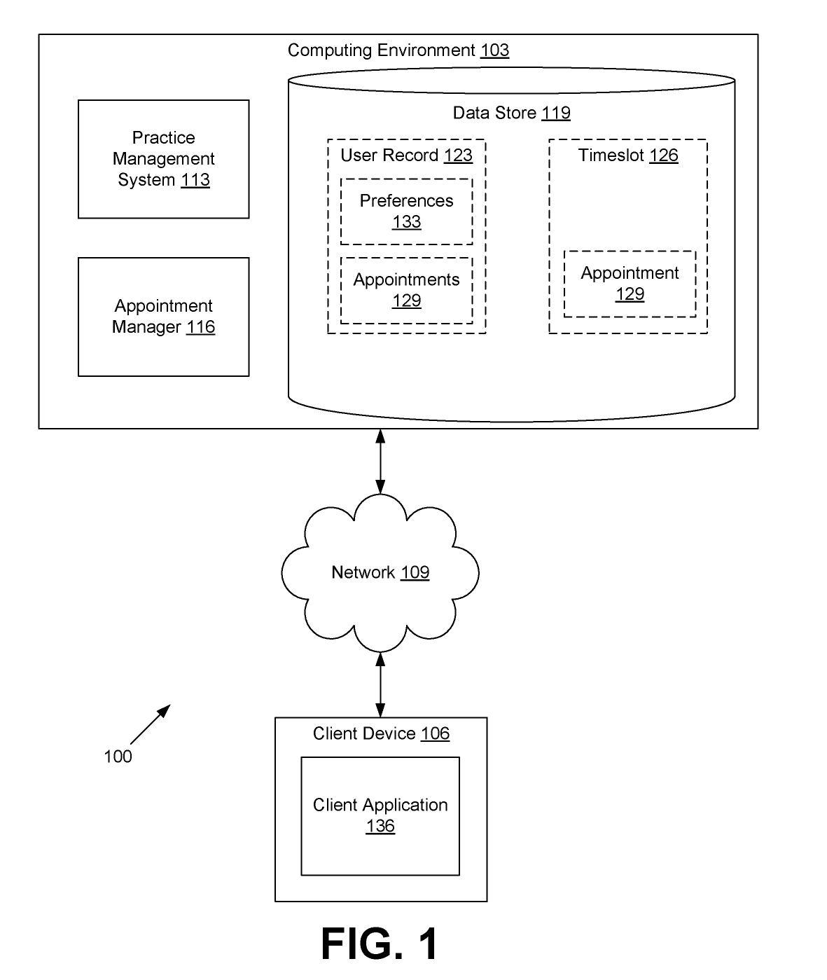

With reference to FIG. 1, shown is a networked environment 100 according to various embodiments. The networked environment 100 includes a computing environment 103 and a client device 106, which are in data communication with each other via a network 109. The network 109 includes wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WF-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 may include, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may include a hosted computing resource, a grid computing resource or any other distributed computing arrangement. In some cases, the computing environment 103 may correspond to an elastic computing resource where the allotted capacity of processing, network, storage, or other computing-related resources may vary over time.

Various applications or other functionality may be executed in the computing environment 103 according to various embodiments. The components executed on the computing environment 103, for example, include a practice management system 113, an appointment manager 116, and other applications, services, processes, systems, engines, or functionality not discussed in detail herein.

The practice management system 113 is executed to assist in the management of a service provider. The practice management system 113 may be executed to capture customer information and demographic data, schedule appointments, perform billing tasks, generate reports, as well as provide other relevant functions. In some embodiments, the functionality of the practice management system 113 may be extended through the use of additional plugins, modules, or packages.

The appointment manager 116 is executed to assist in the creation, cancellation, rescheduling, and filling of appointments. For example, the appointment manager 116 may be executed to identify cancellations and automatically notify other users of the newly free appointment time in an attempt to fill the free appointment slot. While the appointment manager 116 is depicted and discussed separately, the functionality of the appointment manager 116 may be implemented by the practice management system 113 in some embodiments of the present disclosure.

Also, various data is stored in a data store 119 that is accessible to the computing environment 103. The data store 119 may be representative of a plurality of data stores 119, which can include relational databases, object-oriented databases, hierarchical databases, hash tables or similar key-value data stores, as well as other data storage applications or data structures. The data stored in the data store 119 is associated with the operation of the various applications or functional entities described below. This data can include user records 123, timeslots 126, and potentially other data.

The user records 123 represent electronically stored data regarding the users or customers of the service provider. The user records 123 can include a customer's name, contact information, payment information, billing history, service history (e.g., the date of their last appointment 129, the type of services performed at previous appointments 129, etc.), and potentially other data. For example, the user records 123 can include one or more appointments 129 that are currently scheduled for the user, as well as previously schedule or completed appointments 129.

The appointment 129 can include information about when and what kind of service a user is scheduled to receive. For example, the appointment 129 can include the date, time, and duration of the scheduled service, the type of service scheduled, a particular service provider with whom the service is scheduled, and potentially other data. Appointments 129 may remain stored in the system once completed in order to provide historical data as well.

The preferences 133 can include any particular user preferences. Examples can include preferred appointment times, preferred service providers, and preferred methods of contact. Other preferences may also be stored.

The timeslot 126 represents an available date, time, and duration in which a service may be performed. The duration of the timeslot 126 may be configured by the service provider, as appropriate. For example, timeslots 126 may exist in 5, 10, 15, 30, or 60 minute increments. A timeslot 126 may also include an associated appointment 129. The presence of absence of a link between a timeslot 126 and an appointment 129 can be used to indicate whether the timeslot 126 is currently available for a future booking of an appointment. In some instances, an appointment 129 may be scheduled to cover multiple available timeslots 126. In these instances, multiple timeslots 126 may include a reference to the same appointment 129. Moreover, a timeslot 126 can also be associated with a specific service provider (e.g., a specific dental assistant at a dentist's office, a specific doctor at a doctor's office, a specific mechanic at an automotive repair facility, etc.).

The client device 106 is representative of a plurality of client devices that may be coupled to the network 109. The client device 106 may include, for example, a processor-based system such as a computer system. Such a computer system may be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 may include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display may be a component of the client device 106 or may be connected to the client device 106 through a wired or wireless connection.

The client device 106 may be configured to execute various applications such as a client application 136 or other applications. The client application 136 may be executed in a client device 106, for example, to access network content served up by the computing environment 103 or other servers, thereby rendering a user interface on the display. To this end, the client application 136 may include, for example, a browser, a dedicated application, or other executable, and the user interface may include a network page, an application screen, or other user mechanism for obtaining user input. The client device 106 may be configured to execute applications beyond the client application 136 such as, for example, email applications, social networking applications, word processors, spreadsheets, or other applications.

Next, a general description of the operation of the components illustrated in FIG. 1 is provided. To begin, a cancellation of an appointment 129 is detected. This could be detected, for example, by monitoring timeslot 126 or appointment 129 records in the data store 119. Once a cancellation is detected, one of several events may occur. In some embodiments of the present disclosure, the service provider may be notified of the cancellation and presented with an option to notify users of the availability of the timeslot 126. Other embodiments may be configured to automatically notify users. In addition, users may be notified en masse or may be notified sequentially.

For example, in embodiments where users are notified sequentially, a notification is sent to a first user. The notification may be sent, for example, via a short message service (SMS) text message, electronic mail (E-mail), automated voice call, in application messaging, or other messaging mechanism. The notification may include the timeslot(s) 126 of the cancelled appointment 129 and provide the user with an instruction for how to accept or decline scheduling a new appointment 129 for the newly available timeslot(s) 126.

The first user may be selected based on various criteria, such as the first user's appointment history, the first user's presence on a waitlist, or one or more preferences 133 stored in the user record 123 of the user. For example, in the case of a dental practice, the first user may be selected because the first user is due for a routine cleaning, but has not made an appointment 129 yet. As another example, the first user may be selected because he or she has attempted to make an appointment 129, but no timeslots 126 were available. As a third example, the first user may be selected because he or she has already made an appointment 129 but has a user preference 133 that indicates that the first user would like an earlier appointment, if possible.

One of several scenarios may occur in response to the notification being sent to the first user. First, the first user may reply with an indication that he or she would like to create a new appointment 129 for the newly available timeslot(s) 126. Second, the first user may reply declining the offer to create a new appointment 129. Third, no response may be received from the first user. Similarly, a response may be received, but after some predefined period of time has elapsed. For example, the first user may be given the option to create a new appointment 129 for the newly available timeslot(s) 126, but be required to respond within some predefined period of time (e.g., 5 minutes, 10 minutes, 1 hour, etc.).

If the first user responds to the notification and accepts the request, a new appointment 129 for the user corresponding to the timeslot(s) 126 may be automatically created. However, in some implementations, manual intervention may be required to create the new appointment 129 if the first user accepts the request. If the first user declines the request, or fails to respond within the predefined period of time, then a notification may be sent to a second user using a similar process or approach. The second user may be selected in the same or using a similar manner as was used to select the first user. In some embodiments, a list of prospective users may be selected, and each user in the list is sent a notification prompting the user to create an appointment 129 until a user in the list accepts the request for an appointment corresponding to the newly available timeslot(s) 126.

Embodiments where users are notified en masse operate similarly. A group of available users may be notified of the availability of the timeslot 126. The first user to respond accepting the newly available timeslot 126 is then scheduled for that timeslot 126. Later responding users are notified that the timeslot 126 is no longer available. In the event that no users respond accepting the newly available timeslot 126, a second group of users may be notified of the availability of the timeslot 126 in an attempt to fill the newly available timeslot 126.

In any of these embodiments, users may be selected based on a variety of criteria. For example, users may be selected based at least in part on whether or not they are a current or active customer. Users may also be selected based at least in part on whether or not they are past-due for an appointment (e.g., past due for a regular dental cleaning, annual physical, oil-change, etc.). Users may further be selected based at least in part on whether or not they have an appointment currently scheduled. If the users have an appointment currently scheduled, the appointment time may also be considered in some embodiments of the present disclosure. In addition, users may be selected based at least in part on whether or not they have indicated a preference for an earlier appointment, if possible. Further, users may be selected based at least in part on whether they have agreed to receive notifications from the service provider. Other factors may also potentially be used according to various embodiments of the present disclosure.

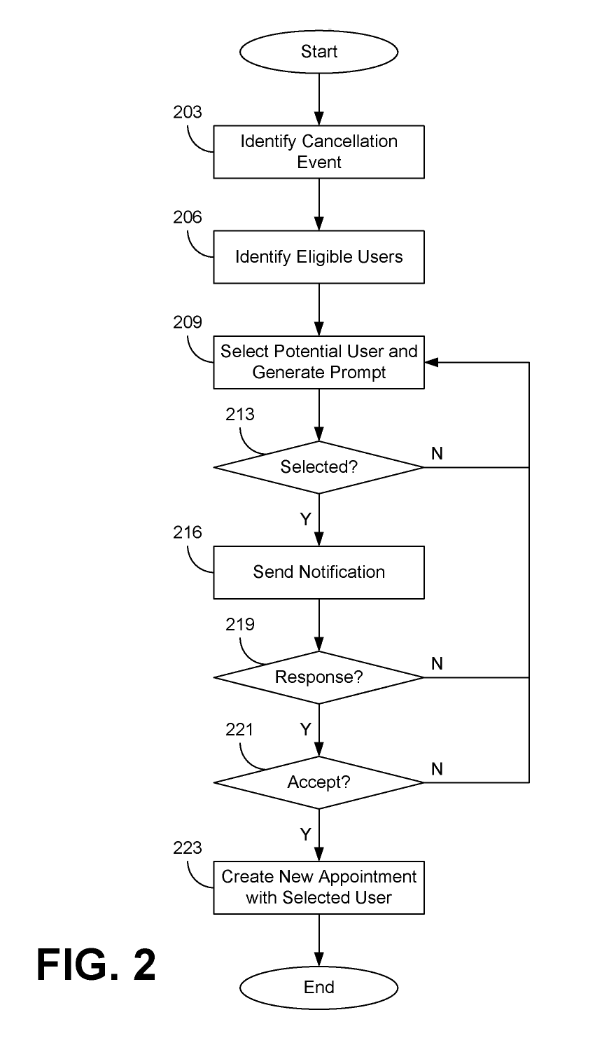

Referring next to FIG. 2, shown is a flowchart that provides one example of the operation of a portion of the appointment manager 116 according to various embodiments. It is understood that the flowchart of FIG. 2 provides merely an example of the many different types of functional arrangements that may be employed to implement the operation of the portion of the appointment manager 116 as described herein. As an alternative, the flowchart of FIG. 2 may be viewed as depicting an example of elements of a method implemented in the computing environment 103 (FIG. 1) according to one or more embodiments.

Beginning with box 203, a cancellation event is detected by the appointment manager 116, the cancellation event representing a cancellation of an appointment 129 by a user. This could be detected using several approaches. For example, when a user cancels an appointment 129 through the practice management system 113, the practice management system 113 could send a notification to the appointment manager 116 indicating that the appointment 129 had been cancelled and that the timeslot(s) 126 associated with the appointment 129 was/were now available. As another example, the appointment manager 116 could periodically query or otherwise poll the appointment 129 records in the data store 119 and the associated timeslots 126 and compare the results of the query with the results of a previous query. For instance, if the appointment manager 116 received a response to a first query that indicated that a timeslot 126 was linked to an appointment 129 associated with a user record 123 and another response to a later, second query that indicated that the timeslot 126 was no longer linked to any appointment 129, the appointment manager 116 could determine that the appointment 129 had been cancelled or rescheduled and the timeslot 126 was now available for fulfillment.

Moving on to box 206, the appointment manager 116 identifies one more user records 123 representing users that could potentially fill the vacant timeslot 126. The appointment manager 116 could use one or more criteria for selecting user records 123. As one example, the appointment manager 116 could check the preferences 133 in a user record 123 to see if the preference 133 indicated that the user represented by the user record 123 would prefer to move a current appointment to the available timeslot 126. For instance, a user could already have an appointment 129 scheduled, but prefer an earlier or “first available” appointment 129 if one became available. Likewise, a user's history, as stored in the user record 123, could be used to select potential users. For example users who have not received service within a predefined period of time (e.g., in the preceding three months, six months, etc.) may be selected. Other criteria may also be used according to various embodiments of the present disclosure.

Proceeding to box 209, the appointment manager 116 selects a potential user and generates a prompt for a user interface. The prompt could include a window to be displayed within an application, a web page, a “pop-up” window for a web application, or other prompt. The prompt would allow an administrative user (e.g., an office manager, scheduling assistant, etc.) to confirm that the selected user is to be notified of the new appointment 129 availability.

Referring next to box 213, the appointment manager 116 determines whether or not the potential user has been selected. For example, the appointment manager 116 may receive a notification, event, or other indication from the prompt or user interface that the administrative user has manipulated the prompt or user interface to confirm, select or otherwise approve of notifying the potential user of the availability of the appointment 129. If the potential user is selected, then the process proceeds to box 216. If the potential user is not selected (e.g., the administrative user manipulates the user interface in such a way as to indicate that another user is to be selected), then the process may loop back to box 209 to allow the administrative user to select another potential user for the appointment 129.

Moving to box 216, the appointment manager 116 sends a notification to the selected user. For example, the appointment manager 116 may cause an email, an SMS message, or an automated phone call to be placed to the user to notify them of the availability of the appointment 129 and prompt the user to accept or decline the new appointment 129.

Proceeding to box 219, the appointment manager 116 waits to receive a response to the notification. If no response is received within a predefined period of time, the appointment manager 116 may proceed back to box 209 to begin selection of a new user to fill the appointment 129. The predefined period of time may be configurable in some embodiments. In some embodiments, each notification method may have its own configurable period of time. As an illustrative example, a user may be give 10 minutes to reply to an SMS message and 1 hour to reply to an email. However, if a response is received within the predefined period of time, then the process proceeds to box 221.

Next at box 221, the appointment manager 116 determines whether the user has accepted or declined the available appointment 129. For example, if a text message were sent to a user asking them to respond “Y” if they wished to accept the newly available appointment 129 and “N” if they wished to decline the newly available appointment, the appointment manager 116 could parse the response to the SMS message to determine whether the user accepted or declined. If the user declined the appointment, the process may loop back to box 209 in order to attempt to fill the newly available appointment 129 with another user. However, if the user accepted the newly available appointment 129, then the process could proceed to box 221.

Referring finally to box 223, the appointment manager 116 may create a new appointment 129 for the timeslot 126 and may store the appointment 129 in the user record 123 representing the user. However, in some implementations, the creation of the new appointment 129 may be manually performed (e.g., by an office administrator in response to a user request for the timeslot 126). Once the appointment 129 is created, the process ends.

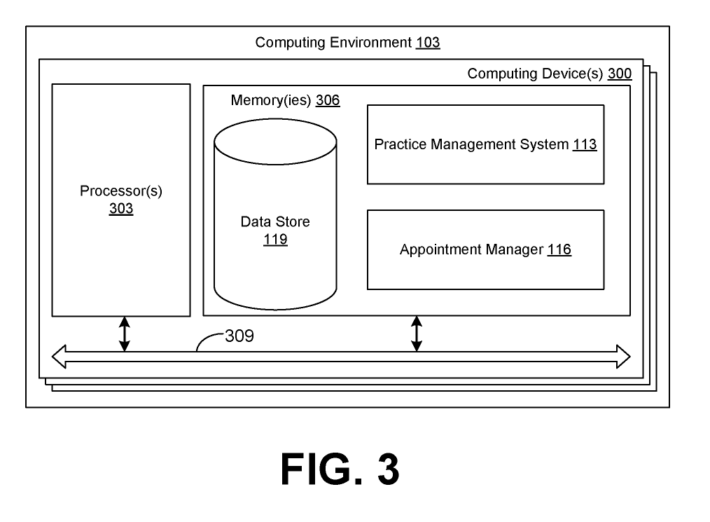

With reference to FIG. 3, shown is a schematic block diagram of the computing environment 103 according to an embodiment of the present disclosure. The computing environment 103 includes one or more computing devices 300. Each computing device 300 includes at least one processor circuit, for example, having a processor 303 and a memory 306, both of which are coupled to a local interface 309. To this end, each computing device 300 may include, for example, at least one server computer or like device. The local interface 309 may include, for example, a data bus with an accompanying address/control bus or other bus structure as can be appreciated.

Stored in the memory 306 are both data and several components that are executable by the processor 303. In particular, stored in the memory 306 and executable by the processor 303 are the practice management system 113, the appointment manager 116, and potentially other applications. Also stored in the memory 306 may be a data store 119 and other data. In addition, an operating system may be stored in the memory 306 and executable by the processor 303.

It is understood that there may be other applications that are stored in the memory 306 and are executable by the processor 303 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 306 and are executable by the processor 303. In this respect, the term “executable” means a program file that is in a form that can ultimately be run by the processor 303. Examples of executable programs may be, for example, a compiled program that can be translated into machine code in a format that can be loaded into a random access portion of the memory 306 and run by the processor 303, source code that may be expressed in proper format such as object code that is capable of being loaded into a random access portion of the memory 306 and executed by the processor 303, or source code that may be interpreted by another executable program to generate instructions in a random access portion of the memory 306 to be executed by the processor 303, etc. An executable program may be stored in any portion or component of the memory 306 including, for example, random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory 306 is defined herein as including both volatile and nonvolatile memory and data storage components. Volatile components are those that do not retain data values upon loss of power. Nonvolatile components are those that retain data upon a loss of power. Thus, the memory 306 may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

Also, the processor 303 may represent multiple processors 303 or multiple processor cores and the memory 306 may represent multiple memories 306 that operate in parallel processing circuits, respectively. In such a case, the local interface 309 may be an appropriate network that facilitates communication between any two of the multiple processors 303, between any processor 303 and any of the memories 306, or between any two of the memories 306. The local interface 309 may include additional systems designed to coordinate this communication, including, for example, performing load balancing. The processor 303 may be of electrical or of some other available construction.

Although the practice management system 113, the appointment manager 116, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 2 shows the functionality and operation of an implementation of portions of the appointment manager 116. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor 303 in a computer system or other system. The machine code may be converted from the source code through various processes. For example, the machine code may be generated from the source code with a compiler prior to execution of the corresponding application. As another example, the machine code may be generated from the source code concurrently with execution with an interpreter. Other approaches can also be used. If embodied in hardware, each block may represent a circuit or a number of interconnected circuits to implement the specified logical function or functions.

Although the flowchart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. Further, in some embodiments, one or more of the blocks shown in FIG. 2 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the practice management system 113, the appointment manager 116, that includes software or code can be embodied in any non-transitory computer-readable medium for use by or in connection with an instruction execution system such as, for example, a processor 303 in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the practice management system 113, the appointment manager 116, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 300, or in multiple computing devices in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine readable instructions stored in the memory that, when executed by the processor, cause the computing device to at least:
identify a cancellation event for an appointment corresponding to a timeslot;
identify an eligible user for a new appointment corresponding to the timeslot; and
send a notification to the eligible user, the notification comprising a request for the eligible user to schedule the new appointment for the timeslot.

2. The system of claim 1, wherein the machine readable instructions further cause the computing device to at least:
generate a user interface in response to identification of the cancellation event, the user interface comprising a prompt to send the notification to the eligible user; and
send the notification to the eligible user in response to a manipulation of the prompt within the user interface.

3. The system of claim 1, wherein the notification comprises a short message service (SMS) message.

4. The system of claim 1, wherein the notification comprises an electronic mail (E-Mail) message.

5. The system of claim 1, wherein the machine readable instructions further cause the computing device to at least:
receive a response from the eligible user, the response indicating an acceptance of the request to schedule the new appointment; and
create the new appointment for the eligible user corresponding to the timeslot.

6. The system of claim 1, wherein the eligible user is a first user in a list of eligible users, the notification is a first notification, the request is a first request, and the machine readable instructions further cause the computing device to at least:
receive a response from the first eligible user, the response indicating a rejection of the request to schedule the new appointment;
identify a second user in the list of eligible users; and
send a second notification to the second user, the second notification comprising a second request for the second eligible user to schedule the new appointment for the timeslot.

7. The system of claim 6, wherein the machine readable instructions further cause the computing device to at least:
receive a response from the second user in the list of eligible users, the response indicating an acceptance of the request to schedule the new appointment; and
create the new appointment for the second user in the list of eligible users corresponding to the timeslot.

8. The system of claim 1, wherein the eligible user is a first user in a list of eligible users, the notification is a first notification, the request is a first request, and the machine readable instructions further cause the computing device to at least:
determine that system has failed to receive a response from the eligible user within a predefined period of time;
identify a second user in the list of eligible users; and
send a second notification to the second user, the second notification comprising a second request for the second eligible user to schedule the new appointment for the timeslot.

9. The system of claim 8, wherein the machine readable instructions further cause the computing device to at least:
receive a response from the second user in the list of eligible users, the response indicating an acceptance of the request to schedule the new appointment; and
create the new appointment for the second user in the list of eligible users corresponding to the timeslot.

10. A computer-implemented method, comprising:
identifying a cancellation event for an appointment corresponding to a timeslot;
identifying an eligible user for a new appointment corresponding to the timeslot; and
sending a notification to the eligible user, the notification comprising a request for the eligible user to schedule the new appointment for the timeslot.

11. The computer-implemented method of claim 10, wherein the notification comprises a short message service (SMS) message.

12. The computer-implemented method of claim 10, wherein the notification comprises an electronic mail (E-Mail) message.

13. The computer-implemented method of claim 10, further comprising:
generating a user interface in response to identification of the cancellation event, the user interface comprising a prompt to send the notification to the eligible user; and
sending the notification to the eligible user in response to a manipulation of the prompt within the user interface.

14. The computer-implemented method of claim 10, further comprising:
receiving a response from the eligible user, the response indicating an acceptance of the request to schedule the new appointment; and
creating the new appointment for the eligible user corresponding to the timeslot.

15. The computer-implemented method of claim 10, wherein the eligible user is a first user in a list of eligible users, the notification is a first notification, the request is a first request, and the method further comprises:
receiving a response from the first eligible user, the response indicating a rejection of the request to schedule the new appointment;
identifying a second user in the list of eligible users; and
sending a second notification to the second user, the second notification comprising a second request for the second eligible user to schedule the new appointment for the timeslot.

16. The computer-implemented method of claim 15, further comprising:
receiving a response from the second user in the list of eligible users, the response indicating an acceptance of the request to schedule the new appointment; and
creating the new appointment for the second user in the list of eligible users corresponding to the timeslot.

17. The computer-implemented method of claim 10, wherein the eligible user is a first user in a list of eligible users, the notification is a first notification, the request is a first request, and the method further comprises:
determining that system has failed to receive a response from the eligible user within a predefined period of time;
identifying a second user in the list of eligible users; and
sending a second notification to the second user, the second notification comprising a second request for the second eligible user to schedule the new appointment for the timeslot.

18. The computer-implemented method of claim 17, further comprising:
receiving a response from the second user in the list of eligible users, the response indicating an acceptance of the request to schedule the new appointment; and
creating the new appointment for the second user in the list of eligible users corresponding to the timeslot.

19. A non-transitory computer readable medium comprising machine readable instructions that, when executed by a processor of a computing device, cause the computing device to at least:
identify a cancellation event for an appointment corresponding to a timeslot;
identify an eligible user for a new appointment corresponding to the timeslot;
generate a user interface in response to identification of the cancellation event, the user interface comprising a prompt to send a notification to the eligible user;
send the notification to the eligible user in response to a manipulation of the prompt within the user interface, the notification comprising a request for the eligible user to schedule the new appointment for the timeslot;
receive a response from the eligible user, the response indicating an acceptance of the request to schedule the new appointment; and
create the new appointment for the eligible user corresponding to the timeslot.

20. The non-transitory computer readable medium of claim 19, wherein the eligible user is a first user in a list of eligible users, the notification is a first notification, the request is a first request, and the machine readable instructions, when executed by the processor, further cause the computing device to at least:
determine that the response from the eligible user has not been received within a predefined period of time;
identify a second user in the list of eligible users; and
send a second notification to the second user, the second notification comprising a second request for the second eligible user to schedule the new appointment for the timeslot.
